(19) United States
(12) Patent Application Publication
(10) Pub. No.: US 2026/0038248 A1
(43) Pub. Date: Feb. 5, 2026

(54) SYSTEM AND METHOD FOR TRAINING A 3D KEYPOINT DETECTION MODEL

(71) Applicant: Quanta Computer Inc., Taoyuan City (TW)

(72) Inventors: Chia-Yuan CHANG, Taoyuan City (TW); Kai-Ju CHENG, Taoyuan City (TW); Yu-Hsun CHEN, Taoyuan City (TW); Chin-Yuan TING, Taoyuan City (TW)

(21) Appl. No.: 18/967,736

(22) Filed: Dec. 4, 2024

(30) Foreign Application Priority Data
Jul. 31, 2024 (TW) 113128460

(51) Int. Cl. G06V 10/774; G06T 7/73; G06V 10/77; G06V 10/82

(52) U.S. Cl. CPC G06V 10/774; G06T 7/73; G06V 10/7715; G06V 10/82; G06T 2207/10028; G06T 2207/20081; G06T 2207/20084

(57) ABSTRACT

A method for training a 3D keypoint detection model is provided. The method includes the step of using a labeled dataset to train a pre-trained model. The method further includes the step of obtaining multiple sets of 3D data associated with a 3D entity from multiple camera devices. The method further includes the step of inputting the multiple sets of 3D data into the pre-trained model to obtain multiple sets of predicted keypoint coordinates output by the pre-trained model. The method further includes the step of generating a self-labeled dataset based on the multiple sets of 3D data and the multiple sets of predicted keypoint coordinates. The method further includes the step of using the self-labeled dataset to train the pre-trained model to create a fine-tuned model.

### CROSS REFERENCE TO RELATED APPLICATIONS

This Application claims priority of Taiwan Patent Application No. 113128460, filed on Jul. 31, 2024, the entirety of which is incorporated by reference herein.

### BACKGROUND OF THE INVENTION

### Field of the Invention

The present invention relates to machine learning and keypoint detection, and, in particular, to a system and method for training a 3D keypoint detection model.

### Description of the Related Art

The application of machine learning techniques in three-dimensional (3D) data analysis is growing. However, numerous technical challenges persist in practice. One key challenge arises from the incompleteness of 3D image data, especially when occluded areas cannot be displayed, making accurate keypoint annotation for 3D entities more difficult. Since most existing keypoint detection models are constructed using supervised learning, the difficulty in labeling training data limits the models' predictive capabilities. As a result, commonly used keypoint detection models, such as OpenPose, High-Resolution Net (HRNet), DeepCut, Regional Multi-Person Pose Estimation (AlphaPose), Deep Pose, PoseNet, Dense Pose, and OpenPifPaf, primarily rely on two-dimensional (2D) images as input and output 2D keypoint coordinates. However, for keypoints on the back or occluded parts of a 3D entity, the accuracy and reliability of these 2D image-based keypoint detection models often fall short of practical application requirements.

Therefore, there is an urgent need for an improved system and method for training 3D keypoint detection models to overcome the aforementioned technical challenges.

### BRIEF SUMMARY OF THE INVENTION

An embodiment of the present invention provides a system for training a 3D keypoint detection model. Th system includes multiple camera devices, a storage unit, and a processing unit. The camera devices are configured to capture a 3D entity from different angles. The storage unit stores a program. The processing unit loads the program from the storage unit to execute the following steps. The processing unit uses a labeled dataset to train a pre-trained model. The processing unit obtains multiple sets of 3D data associated with the 3D entity from the camera devices. The processing unit inputs the multiple sets of 3D data into the pre-trained model to obtain multiple sets of predicted keypoint coordinates output by the pre-trained model. Each set of predicted keypoint coordinates includes predicted coordinates of multiple keypoints of the 3D entity. The processing unit generates a self-labeled dataset based on the multiple sets of 3D data and the multiple sets of predicted keypoint coordinates. The processing unit uses the self-labeled dataset to train the pre-trained model to create a fine-tuned model.

In an embodiment, the processing unit further executes the following steps to generate the self-labeled dataset. The processing unit transforms the multiple sets of predicted keypoint coordinates into multiple sets of aligned keypoint coordinates on a unified coordinate system. Each set of aligned keypoint coordinates includes the aligned coordinates corresponding to the keypoints. The processing unit calculates a set of representative keypoint coordinates on the unified coordinate system based on the multiple sets of aligned keypoint coordinates. The set of representative keypoint coordinates includes representative coordinates corresponding to the keypoints. The processing unit transforms the set of representative keypoint coordinates into multiple sets of keypoint coordinate labels on camera coordinate systems corresponding to the multiple camera devices. The set of keypoint coordinate labels corresponding to each camera device, together with the set of 3D data obtained from that camera device, forms a set of self-labeled data in the self-labeled dataset.

In an embodiment, the processing unit further excludes an outlier from the aligned coordinates corresponding to each keypoint, and calculates the representative coordinate corresponding to the keypoint based on the remaining aligned coordinates.

In an embodiment, the processing unit further converts raw images or depth maps, obtained by the camera devices capturing the 3D entity, into 3D point clouds, and uses the 3D point clouds as the multiple sets of 3D data.

In an embodiment, the pre-trained model and the fine-tuned model are implemented based on a 3D convolutional neural network.

An embodiment of the present invention provides a computer-implemented method for training a 3D keypoint detection model. The method includes the step of using a labeled dataset to train a pre-trained model. The method further includes the step of obtaining multiple sets of 3D data associated with a 3D entity from multiple camera devices which capture the 3D entity from different angles. The method further includes the step of inputting the multiple sets of 3D data into the pre-trained model to obtain multiple sets of predicted keypoint coordinates output by the pre-trained model. Each set of predicted keypoint coordinates includes predicted coordinates of multiple keypoints of the 3D entity. The method further includes the step of generating a self-labeled dataset based on the multiple sets of 3D data and the multiple sets of predicted keypoint coordinates. The method further includes the step of using the self-labeled dataset to train the pre-trained model to create a fine-tuned model.

In an embodiment, the step of generating the self-labeled dataset based on the multiple sets of 3D data and the multiple sets of predicted keypoint coordinates further includes the following steps. The multiple sets of predicted keypoint coordinates are transformed into multiple sets of aligned keypoint coordinates on a unified coordinate system. Each set of aligned keypoint coordinates includes the aligned coordinates corresponding to the keypoints. A set of representative keypoint coordinates is calculated on the unified coordinate system based on the multiple sets of aligned keypoint coordinates. The set of representative keypoint coordinates includes representative coordinates corresponding to the keypoints. The set of representative keypoint coordinates is transformed into multiple sets of keypoint coordinate labels on camera coordinate systems corresponding to the multiple camera devices. The set of keypoint coordinate labels corresponding to each camera device, together with the set of 3D data obtained from that camera device, forms a set of self-labeled data in the self-labeled dataset.

In an embodiment, the step of calculating the set of representative keypoint coordinates on the unified coordinate system based on the multiple sets of aligned keypoint coordinates further includes excluding an outlier from the aligned coordinates corresponding to each keypoint, and calculating the representative coordinate corresponding to the keypoint based on the remaining aligned coordinates.

In an embodiment, the step of obtaining the multiple sets of 3D data associated with the 3D entity from multiple camera devices further includes converting raw images or depth maps, obtained by the camera devices capturing the 3D entity, into 3D point clouds, and using the 3D point clouds as the multiple sets of 3D data.

### BRIEF DESCRIPTION OF THE DRAWINGS

The present invention can be more fully understood by reading the subsequent detailed description and examples with references made to the accompanying drawings, wherein:

FIG. 1 is a system block diagram of a system for training a 3D keypoint detection model, according to an embodiment of the present disclosure;

FIG. 2 is a schematic diagram of an example configuration of camera devices, according to an embodiment of the present disclosure;

FIG. 3A is a flow diagram of a method for training a 3D keypoint detection model, according to an embodiment of the present disclosure;

FIG. 3B is a data flow diagram of a method for training a 3D keypoint detection model, according to an embodiment of the present disclosure;

FIG. 4 is a flow diagram illustrating more detailed steps of the generation of the self-labeled dataset based on the multiple sets of 3D data and the multiple sets of predicted keypoint coordinates, according to an embodiment of the present disclosure; and

FIG. 5 illustrates an example of excluding an outlier from the aligned coordinates corresponding to each keypoint, and calculating the representative coordinate corresponding to the keypoint based on the remaining aligned coordinates

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

In general, the solution disclosed herein for training 3D keypoint detection models uses a semi-supervised learning approach. Specifically, this solution involves capturing a 3D entity from multiple angles to obtain multiple sets of 3D data, using a pre-trained model to predict the keypoints of the 3D entity based on each set of 3D data, and then integrating the multiple sets of predicted results corresponding to the 3D data into self-labeled data. The self-labeled data is subsequently used to further train and fine-tune the model for optimization.

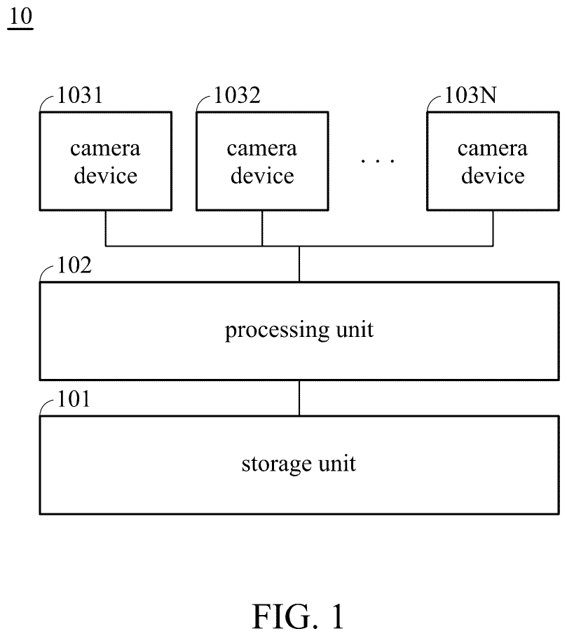

FIG. 1 is a system block diagram of a system 10 for training a 3D keypoint detection model, according to an embodiment of the present disclosure. As shown in FIG. 1, the system 10 includes a storage unit 101, a processing unit 102, and multiple camera devices 1031-103N. The system 10 communicates with the multiple camera devices 1031-103N to obtain images captured by these devices for subsequent processing and analysis by the processing unit 102.

The storage unit 101 may be any device that includes non-volatile memory, such as read-only memory (ROM), electrically-erasable programmable read-only memory (EEPROM), flash memory, or non-volatile random access memory (NVRAM), including devices such as a hard disk drive (HDD), solid-state drive (SSD), or optical disk, but the present disclosure is not limited thereto.

The processing unit 102 may include any one or more general-purpose or specialized processors and the combinations thereof for executing instructions. In a typical embodiment, the processing unit 102 may include a central processing unit (CPU) and a graphics processing unit (GPU), with the GPU being more efficient than the CPU in handling machine learning-related tasks. Accordingly, tasks may be assigned based on the characteristics of the CPU and GPU; for example, tasks involving image data acquisition or communication with other devices can be assigned to the CPU, while tasks related to image analysis and model training can be assigned to the GPU. In a further embodiment, the processing unit 102 may also include a neural processing unit (NPU) optimized specifically for deep learning. Compared to the GPU, the NPU offers higher computational performance for operating deep neural networks. Therefore, handling deep neural network-related tasks can be assigned to the NPU, but the present disclosure is not limited thereto.

According to an embodiment of the present disclosure, the storage unit 101 stores a program that includes a sequence or set of instructions for execution by a computer system. The program may be written in any one or more programming languages, such as Java, C, C#, C++, Python, etc., but the present disclosure is not limited thereto. Upon loading the program from the storage unit 101, the processing unit 102 can execute the method disclosed herein for training a 3D keypoint detection model.

The storage unit 101 and the processing unit 102 can be housed in any computing device with processing capabilities, such as a personal computer (e.g., a desktop or laptop) or a server computer, or a mobile device such as a tablet or smartphone, but the present disclosure is not limited thereto. The computing device can communicate with the camera devices 1031-103N via various wired or wireless communication interfaces to obtain images or depth data captured by these camera devices as the basis for keypoint detection. The communication interface can be a wired interface, such as Ethernet, High Definition Multimedia Interface (HDMI), Universal Serial Bus (USB), or RS-232/RS-485, or a wireless interface, such as 5th Generation (5G) wireless systems, Bluetooth, WiFi, Near Field Communication (NFC), or Zigbee, but the present disclosure is not limited thereto.

Each of the camera devices 1031-103N may include a lens and a conversion element. The lens may include one or more lenses, such as a zoom lens to magnify or reduce the size of the target object and a focus lens to adjust the focal distance of the target object. The conversion element can be, for example, a charge-coupled device (CCD) or a complementary metal-oxide-semiconductor (CMOS) to receive the optical signal from the lens and convert it into an electrical signal.

In some embodiments, the camera devices 1031-103N are depth cameras capable of capturing depth information of the 3D target entity being photographed. Based on different technical principles, depth cameras can be divided into three types: Time-of-Flight (ToF) cameras, structured light cameras, and stereo vision cameras. A ToF camera calculates distance (i.e., depth) by emitting laser or pulsed light at a 3D target entity and then measuring the time it takes for the light to reflect back. A structured light camera projects light with specific structural features (e.g., a known pattern), typically infrared, onto the 3D target entity and uses specialized lenses to capture the deformation of the reflected pattern to infer distance. A stereo vision camera captures two images of the same target entity from two lenses and calculates the distance by comparing the positional differences (i.e., parallax) of corresponding points in the two images. The camera devices 1031-103N may be any of the aforementioned types of depth cameras. The type of depth camera used is not limited by the present disclosure.

Furthermore, the distance of each pixel captured by a depth camera can constitute a depth map, which can then be converted into a 3D point cloud through coordinate transformation. This conversion from depth map to 3D point cloud can be implemented by a processor equipped within the depth camera. Alternatively, the depth camera may transmit the depth map to the back-end processing unit 102, which then performs the conversion from depth map to 3D point cloud. If the camera devices 1031-103N are stereo vision cameras, they may transmit the captured raw images to the back-end processing unit 102, which then estimates the depth map based on the raw images and subsequently converts the depth map to a 3D point cloud. In summary, whether the conversion from depth map to 3D point cloud is performed by either the camera devices 1031-103N or the processing unit 102, is not limited by the present disclosure.

In an embodiment, the camera devices 1031-103N are not depth cameras but rather standard monocular cameras. In this case, the processing unit 102 performs monocular depth estimation on the 2D images captured by the monocular cameras to obtain 3D data associated with the 3D target entity. Monocular depth estimation is typically achieved through a deep learning model, but the present disclosure is not limited thereto.

In various embodiments of the present disclosure, there is no limitation on the number of camera devices 1031-103N. The greater the number of deployed camera devices 1031-103N, the more data the processing unit 102 can obtain regarding multiple aspects of the 3D target entity; however, hardware and computational costs also increase. In a typical embodiment, the number of camera devices 1031-103N is three, which provides the most cost-effective configuration.

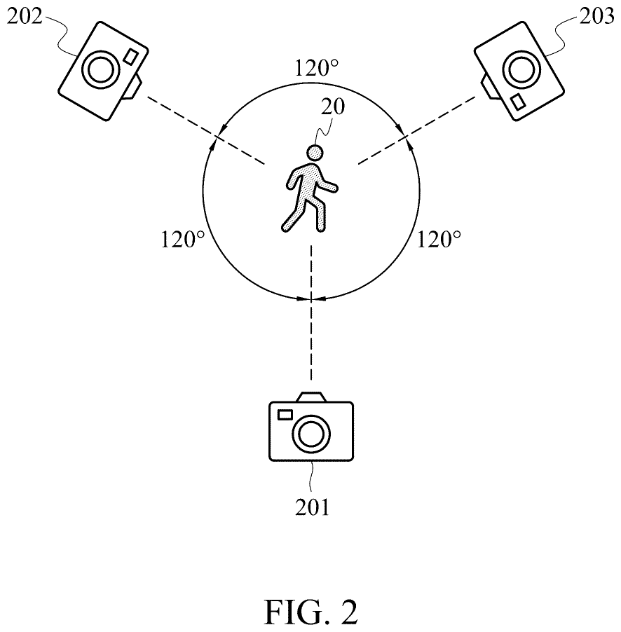

FIG. 2 is a schematic diagram of an example configuration of camera devices, according to an embodiment of the present disclosure. In the example of FIG. 2, three camera devices 201, 202, and 203 are configured to capture the 3D entity 20 from different angles. This allows the processing unit 102 to obtain data on three different aspects of the 3D target entity. These data are integrated into the training data for the keypoint detection model, effectively improving the model's ability to detect (including identify and locate) keypoints on occluded parts.

It should be appreciated that the configuration as shown in FIG. 2 is used to collect training data during the training phase of the keypoint detection model. In the inference phase of the model, that is, during testing or actual application, only a single camera device is needed to capture the 3D target entity to predict the 3D coordinates of all keypoints, including those located in areas not visible to the camera device.

Additionally, it should be appreciated that FIG. 2 is merely a typical example configuration, assuming that the three camera devices 201, 202, and 203 are equidistant from the 3D entity 20 and positioned on the same horizontal plane, with an angle of 120 degrees between each pair of devices, to ensure comprehensive data capture from three different angles. However, aside from not limiting the number of camera devices, the present disclosure does not restrict the camera devices to being equidistant from the 3D target entity, positioned at the same height, or having fixed angles between each other. In various embodiments, the specific configuration of the camera devices can be adaptively adjusted based on practical requirements and/or environmental constraints.

It should be noted that although the 3D entity 20 in FIG. 2 is denoted by a human icon, the present disclosure does not restrict the 3D entity subject to keypoint detection to being a human body. In various embodiments, the 3D entity may be an animal, a plant, or an object such as a building, vehicle, or furniture, but the present disclosure is not limited thereto.

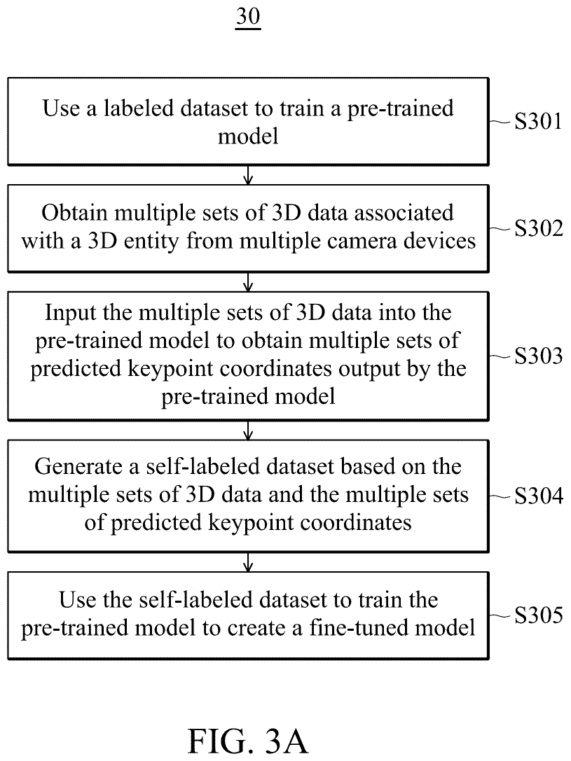

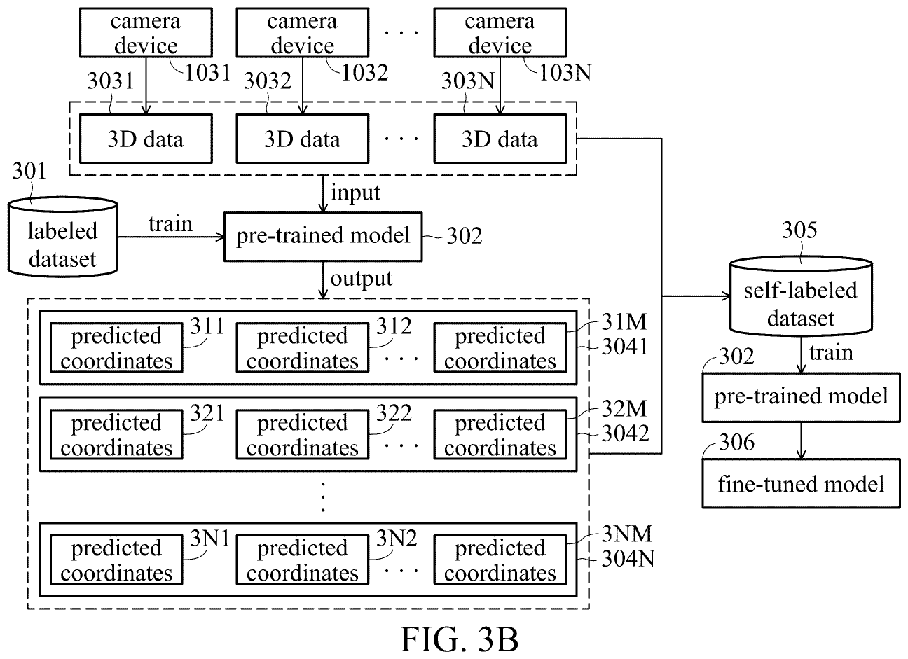

FIG. 3A is a flow diagram of a method 30 for training a 3D keypoint detection model, according to an embodiment of the present disclosure. As shown in FIG. 3A, the method 30 includes steps S301-S305. These steps are executed by the processing unit 102. Corresponding to FIG. 3A, FIG. 3B is a data flow diagram of the method 30. It is recommended to refer to FIG. 3A, FIG. 3B, and the following description together to clearly understand this embodiment.

In step S301, a labeled dataset 301 is used to train a pre-trained model 302.

The labeled dataset 301 may be selected from public datasets such as COCO (Common Objects in Context), MPII Human Pose Dataset, PoseTrack Dataset, or Human3.6M. Each piece of labeled data in the labeled dataset 301 includes a set of 3D data associated with the 3D entity (e.g., 3D point cloud or mesh) and 3D coordinates of the keypoints of the 3D entity as ground truth annotations. Thus, in step S301, supervised learning can be used to establish the pre-trained model 302. However, since each piece of labeled data in the labeled dataset 301 has less accurate keypoint annotations for occluded parts, the predictive capability of the pre-trained model 302 is limited. Therefore, further steps S302-S305 are needed to fine-tune the pre-trained model 302.

The pre-trained model 302 is a multi-output regression model trained to predict the 3D coordinates (e.g., x, y, z coordinates) of the keypoints of a 3D entity based on 3D data inputs. The pre-trained model 302 can be implemented using various machine learning algorithms, such as a neural network (NN), convolutional neural network (CNN), random forest regression, support vector regression (SVR), K-nearest neighbors regression (KNN regression), or gradient boosting regression (GBR), but the present disclosure is not limited thereto.

In an embodiment, the pre-trained model 302 (as well as the fine-tuned model 306) is implemented using a 3D convolutional neural network (CNN). During the training process of the pre-trained model 302, the algorithm performs backpropagation to adjust the weights of the convolutional kernels based on the quality of each inference result. The quality of the inference result can be evaluated by the loss value calculated using a loss function. More specifically, the algorithm updates the parameters of the convolutional kernels based on the gradient information from the loss function to reduce the loss value and thereby improve the model's prediction accuracy. This process continues until the inference results meet the predetermined performance standards. Examples of loss functions applicable to this embodiment are provided below; however, the present disclosure is not limited to these examples.

### (1). Mean Squared Error (MSE)

$$MSE = \frac{1}{N} {\sum }_{i = 1}^{N} {\sum }_{j = 1}^{M} {‖ {\hat{p}}_{ij} - {p}_{ij} ‖}^{2} \qquad Formula$$

Explanation: MSE calculates the average of the squared differences between the predicted and true values. In the formula, N represents the number of samples, i.e., the entries in the labeled dataset used for training; M represents the number of specified keypoints to detect, such as 16, 20, or 25 keypoints; \hat{p}ᵢⱼ represents the predicted coordinates of the i-th keypoint in the j-th sample; and pᵢⱼ represents the true coordinates of the j-th keypoint in the i-th sample, which are the 3D coordinate annotations for that keypoint.

### (2). Root Mean Squared Error (RMSE)

$$RMSE = \sqrt{\frac{1}{N} {\sum }_{i = 1}^{N} {\sum }_{j = 1}^{M} {‖ {\hat{p}}_{ij} - {p}_{ij} ‖}^{2}} \qquad Formula$$

Explanation: RMSE is the square root of MSE.

### (3). Mean Absolute Error (MAE)

$$MAE = \frac{1}{N} {\sum }_{i = 1}^{N} {\sum }_{j = 1}^{M} ‖ {\hat{p}}_{ij} - {p}_{ij} ‖ \qquad Formula$$

Explanation: MAE calculates the average of the absolute differences between the predicted and true values.

### (4). Custom Weighted Loss

$$Weighted Loss = \frac{1}{N} {\sum }_{i = 1}^{N} {\sum }_{j = 1}^{M} {w}_{j} {‖ {\hat{p}}_{ij} - {p}_{ij} ‖}^{2} \qquad Formula$$

Explanation: If certain keypoints are more important than others, different weights can be assigned to different keypoints. In the formula, wⱼ represents the weight of the j-th keypoint.

Refer back to FIG. 3A and FIG. 3B. In step S302, multiple sets of 3D data associated with the 3D entity are obtained from multiple camera devices. For example, a set of 3D data 3031 associated with the 3D entity is obtained from camera device 1031, a set of 3D data 3032 is obtained from camera device 1032, and a set of 3D data 303N is obtained from camera device 103N, and so forth.

Depending on the input type accepted by the pre-trained model, each set of 3D data may be in the form of any data type capable of representing three-dimensional information for multiple points, such as 3D point clouds, depth maps, meshes, or voxels, but the present disclosure is not limited thereto.

In an embodiment, step S302 further involves converting the raw images or depth maps obtained by the camera devices 1031-103N capturing the 3D entity into 3D point clouds, and using these 3D point clouds as the multiple sets of 3D data 3031-303N. More specifically, if the camera devices 1031-103N are depth cameras, they transmit the depth maps to the back-end processing unit 102, which then performs the conversion from depth maps to 3D point clouds through coordinate transformation. If the camera devices 1031-103N are stereo vision cameras, they can transmit the captured raw images to the back-end processing unit 102, where the processing unit 102 estimates the depth maps based on the raw images and then converts the depth maps into 3D point clouds through coordinate transformation.

Refer back to FIG. 3A and FIG. 3B. In step S303, the multiple sets of 3D data 3031-303N are input into the pre-trained model 302 to obtain multiple sets of predicted keypoint coordinates 3041-304N output by the pre-trained model 302. Each set of predicted keypoint coordinates includes predicted coordinates for multiple keypoints of the 3D entity. For example, the set of predicted keypoint coordinates 3041 includes the predicted coordinates of M keypoints of the 3D entity, output by the pre-trained model 302 based on the input of the 3D data 3031, such as the predicted coordinates 311 for the first keypoint, 312 for the second keypoint, and 31M for the M-th keypoint, and so on. The set of predicted keypoint coordinates 3042 includes the predicted coordinates of the M keypoints of the 3D entity, output by the pre-trained model 302 based on the input of the 3D data 3032, such as the predicted coordinates 321 for the first keypoint, 322 for the second keypoint, and 32M for the M-th keypoint, and so on. The set of predicted keypoint coordinates 304N includes the predicted coordinates of the M keypoints of the 3D entity, output by the pre-trained model 302 based on the input of the 3D data 303N, such as the predicted coordinates 3N1 for the first keypoint, 3N2 for the second keypoint, and 3NM for the M-th keypoint, and so on.

In step S304, a self-labeled dataset 305 is generated based on the multiple sets of 3D data 3031-303N and the multiple sets of predicted keypoint coordinates 3041-304N. More specifically, step S304 involves referencing the multiple sets of predicted keypoint coordinates 3041-304N to automatically generate a set of keypoint coordinate labels, with each set of keypoint coordinate labels, along with its corresponding set of 3D data, forming a set of self-labeled data in the self-labeled dataset 305.

In step S305, the self-labeled dataset 305 is used to train the pre-trained model 302 to create a fine-tuned model 306.

The trained fine-tuned model 306 can be deployed on the system 10 or another computing device for 3D keypoint detection of a 3D entity. As mentioned previously, in the inference phase of the fine-tuned model 306, a single 3D data view obtained from a single camera device is sufficient to detect the 3D coordinates of all keypoints of the 3D entity captured by that camera device, including keypoints in areas not directly visible to the camera. The detection results can be presented to the user through output devices such as a display, printer, or projector, or provided to other applications or systems via an application programming interface (API) for further processing, analysis, and application, such as anomaly detection, posture assessment, motion analysis, and real-time interaction in virtual reality (VR) or augmented reality (AR).

Since the self-labeled dataset 305 used to train the fine-tuned model 306 references results predicted by the pre-trained model 302 based on 3D data obtained from multiple aspects, the fine-tuned model 306, as a keypoint detection model, can more accurately identify and locate each keypoint of the 3D target entity, including those parts that may be easily occluded or difficult to detect from a single angle or viewpoint. By integrating data from multiple angles, the self-labeled dataset 305 enhances the accuracy and consistency of keypoints, enabling the fine-tuned model 306 to adapt more effectively to complex 3D environments in practical applications, thereby improving the overall performance of keypoint detection.

It should be appreciated that, since the camera devices 1031-103N capture the 3D entity from different angles (and, naturally, from different positions), the 3D data (e.g., 3D point clouds) obtained from the camera devices 1031-103N are likely to be in relative coordinates with the origin (0,0,0) at each camera device's position. Consequently, the coordinate values for a certain point in space obtained by the different camera devices 1031-103N may differ. To address this situation, in some embodiments, it is needed to transform the multiple sets of 3D data obtained from the camera devices 1031-103N into a unified coordinate system to correctly integrate them into self-labeled data.

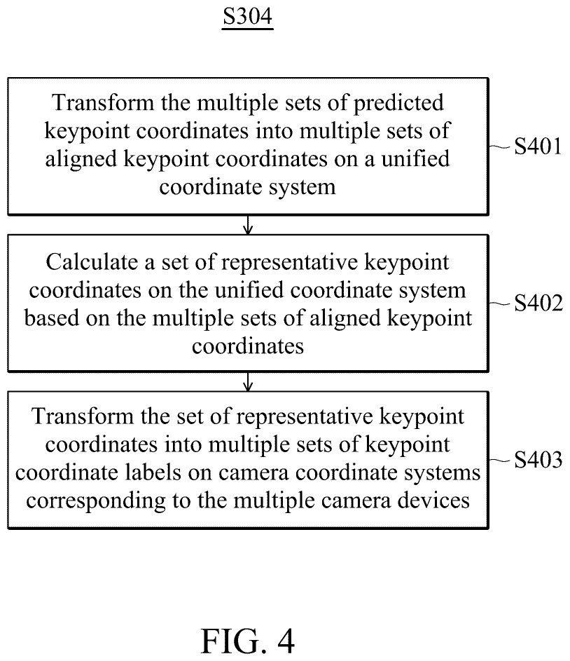

FIG. 4 is a flow diagram illustrating more detailed steps of step S304, according to an embodiment of the present disclosure. As shown in FIG. 4, step S304 may further include steps S401-S403.

In step S401, the multiple sets of predicted keypoint coordinates 3041-304N are transformed into multiple sets of aligned keypoint coordinates on a unified coordinate system. Each set of aligned keypoint coordinates includes the aligned coordinates corresponding to the keypoints.

The unified coordinate system may be a coordinate system with the origin at the position of one of the camera devices 1031-103N, or a system defined with the origin at the central point of the camera devices 1031-103N or at a reference point in space, but the present disclosure is not limited thereto.

In an implementation, the unification of the coordinate system can be achieved based on the spatial transformation relationships between the camera devices 1031-103N, such as translation and rotation. The spatial transformation relationships between the camera devices 1031-103N may be predefined (i.e., the camera devices 1031-103N are arranged according to a predefined spatial transformation relationship) or obtained through actual measurement (for example, if environmental constraints prevent the camera devices 1031-103N from being configured according to a predefined spatial transformation relationship). The spatial transformation relationship can be represented using matrices, where a translation matrix handles the translation of coordinates, and a rotation matrix handles the rotation of coordinates. Through matrix multiplication, the multiple sets of predicted keypoint coordinates 3041-304N can be aligned to the unified coordinate system, resulting in the aforementioned multiple sets of aligned keypoint coordinates.

Using FIG. 2 as an example, let (x,y,z) represent the coordinates of the nose of the 3D entity 20 in the coordinate system of camera device 201, as predicted by the pre-trained model 302 based on the 3D data obtained from camera device 201, and let (a,b,c) represent the coordinates of the nose of the 3D entity 20 in the coordinate system of camera device 203, as predicted by the pre-trained model 302 based on the 3D data obtained from camera device 203. Assuming the coordinate system of camera device 201 is the unified coordinate system, a rotation matrix M₁₂₀ with a rotation angle of 120 degrees can be used to align (a,b,c) with the coordinate system of camera device 201 through matrix multiplication, i.e., (a,b,c)*M₁₂₀. However, even though both (x,y,z) and (a,b,c)*M₁₂₀ correspond to the nose of the same 3D entity 20, they are predictions by the pre-trained model 302 and inevitably contain errors, resulting in a discrepancy therebetween. Similarly, let (d,e,f) represent the coordinates of the nose of the 3D entity 20 in the coordinate system of camera device 202, as predicted by the pre-trained model 302 based on the 3D data obtained from camera device 202. Then (d,e,f)*M₂₄₀ will also have a discrepancy from (x,y,z). Consequently, (x, y, z), (a,b,c)*M₁₂₀, and (d,e,f)*M₂₄₀ form three different aligned coordinates corresponding to the nose of the 3D entity 20.

Refer back to FIG. 4. In step S402, a set of representative keypoint coordinates on the unified coordinate system is calculated based on the multiple sets of aligned keypoint coordinates. This set of representative keypoint coordinates includes representative coordinates corresponding to each keypoint of the 3D entity.

The representative coordinates can be any coordinates that reflect the central tendency of the multiple aligned keypoints corresponding to a keypoint, such as the centroid of these aligned keypoints or the center of the minimum enclosing sphere, but the present disclosure is not limited thereto. For example, assuming there are three camera devices, and for the first keypoint, the pre-trained model 302 outputs the corresponding predicted coordinates 311, 321, and 3N1. These predicted coordinates are aligned to the unified coordinate system in step S401, becoming aligned keypoint coordinates P₁(x₁,y₁,z₁), P₂(x₂,y₂,z₂), and P₃(x₃,y₃,z₃). Then, in step S402, the centroid coordinates of P₁(x₁,y₁,z₁), P₂(x₂,y₂,z₂), and P₃(x₃,y₃,z₃), i.e.,

$$( \frac{{x}_{1} + {x}_{2} + {x}_{3}}{3} , \frac{{y}_{1} + {y}_{2} + {y}_{3}}{3} , \frac{{z}_{1} + {z}_{2} + {z}_{3}}{3} ) ,$$

can be used as the representative coordinates for the first keypoint.

In an embodiment, in step S402, an outlier may be excluded from the aligned coordinates corresponding to each keypoint, and the representative coordinates corresponding to the keypoint are then calculated based on the remaining aligned coordinates. An outlier refers to an aligned coordinate that shows a significant difference from other aligned coordinates for the same keypoint, and thus may have relatively low reference value. Excluding such outliers can improve the accuracy of the self-labeled data.

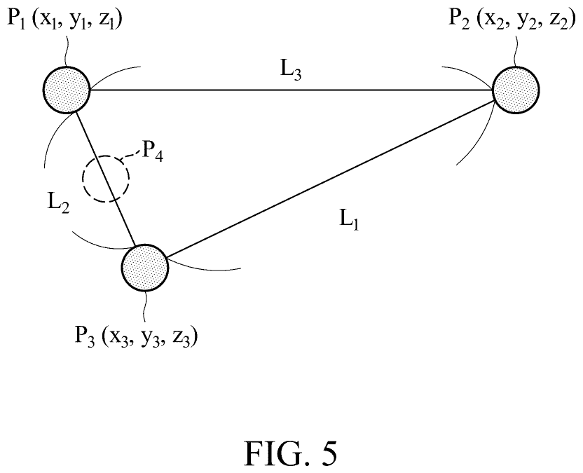

FIG. 5 illustrates an example of excluding the outlier P₂(x₂, y₂, z₂) from the aligned coordinates P₁(x₁,y₁,z₁), P₂(x₂,y₂,z₂), and P₃(x₃,y₃,z₃), and then calculating the representative coordinates for the first keypoint based on the remaining aligned coordinates P₁(x₁,y₁,z₁) and P₃(x₃,y₃,z₃). There are various approaches to the identification of the outlier P₂(x₂,y₂,z₂), and the present disclosure is not limited thereto. One approach is to calculate the distance L₃ between P₁ and P₂, the distance L₂ between P₁ and P₃, and the distance L₁ between P₃ and P₂. The smallest distance L₂ can then be used to identify the outlier P₂(x₂,y₂,z₂), which is opposite the side of length L₂ in the triangle formed by P₁, P₂, and P₃. Another approach is to calculate the centroid of P₁(x₁,y₁,z₁), P₂(x₂,y₂,z₂), and P₃(x₃,y₃,z₃), which is

$$( \frac{{x}_{1} + {x}_{2} + {x}_{3}}{3} , \frac{{y}_{1} + {y}_{2} + {y}_{3}}{3} , \frac{{z}_{1} + {z}_{2} + {z}_{3}}{3} ) ,$$

and then find the point with the greatest distance from this centroid among P₁(x₁, y₁,z₁), P₂(x₂,y₂,z₂), and P₃(x₃,y₃,z₃). Once the outlier P₂(x₂,y₂,z₂) is identified by either approach, the midpoint coordinates of P₁(x₁,y₁,z₁) and P₃(x₃,y₃,z₃), denoted as P₄, can be used as the representative coordinates for the first keypoint.

Refer back to FIG. 4. In step S403, the set of representative keypoint coordinates is transformed into multiple sets of keypoint coordinate labels on the camera coordinate systems corresponding to the camera devices 1031-103N. Each set of keypoint coordinate labels corresponding to a camera device, together with the set of 3D data obtained from that camera device, forms a set of self-labeled data in the self-labeled dataset 305. For example, the set of keypoint coordinate labels corresponding to camera device 1031, along with the 3D data 3031, forms the first set of self-labeled data; the set of keypoint coordinate labels corresponding to camera device 1032, along with the 3D data 3032, forms the second set of self-labeled data; and the set of keypoint coordinate labels corresponding to camera device 103N, along with the 3D data 303N, forms the n-th set of self-labeled data, and so on.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for training a 3D keypoint detection model, comprising:
multiple camera devices, configured to capture a 3D entity from different angles;
a storage unit, configured to store a program; and
a processing unit, configured to load the program from the storage unit to execute following steps:
using a labeled dataset to train a pre-trained model;
obtaining multiple sets of 3D data associated with the 3D entity from the camera devices;
inputting the multiple sets of 3D data into the pre-trained model to obtain multiple sets of predicted keypoint coordinates output by the pre-trained model, wherein each set of predicted keypoint coordinates comprises predicted coordinates of multiple keypoints of the 3D entity;
generating a self-labeled dataset based on the multiple sets of 3D data and the multiple sets of predicted keypoint coordinates; and
using the self-labeled dataset to train the pre-trained model to create a fine-tuned model.

2. The system as claimed in claim 1, wherein the processing unit further executes following steps to generate the self-labeled dataset:
transforming the multiple sets of predicted keypoint coordinates into multiple sets of aligned keypoint coordinates on a unified coordinate system, wherein each set of aligned keypoint coordinates includes the aligned coordinates corresponding to the keypoints;
calculating a set of representative keypoint coordinates on the unified coordinate system based on the multiple sets of aligned keypoint coordinates, wherein the set of representative keypoint coordinates includes representative coordinates corresponding to the keypoints; and
transforming the set of representative keypoint coordinates into multiple sets of keypoint coordinate labels on camera coordinate systems corresponding to the multiple camera devices;
wherein the set of keypoint coordinate labels corresponding to each camera device, together with the set of 3D data obtained from that camera device, forms a set of self-labeled data in the self-labeled dataset.

3. The system as claimed in claim 2, wherein the processing unit further excludes an outlier from the aligned coordinates corresponding to each keypoint, and calculates the representative coordinate corresponding to the keypoint based on the remaining aligned coordinates.

4. The system as claimed in claim 1, wherein the processing unit further converts raw images or depth maps, obtained by the camera devices capturing the 3D entity, into 3D point clouds, and uses the 3D point clouds as the multiple sets of 3D data.

5. The system as claimed in claim 1, wherein the pre-trained model and the fine-tuned model are implemented based on a 3D convolutional neural network.

6. A computer-implemented method for training a 3D keypoint detection model, comprising following steps:
using a labeled dataset to train a pre-trained model;
obtaining multiple sets of 3D data associated with a 3D entity from multiple camera devices, wherein the camera devices capture the 3D entity from different angles;
inputting the multiple sets of 3D data into the pre-trained model to obtain multiple sets of predicted keypoint coordinates output by the pre-trained model, wherein each set of predicted keypoint coordinates includes predicted coordinates of multiple keypoints of the 3D entity;
generating a self-labeled dataset based on the multiple sets of 3D data and the multiple sets of predicted keypoint coordinates; and
using the self-labeled dataset to train the pre-trained model to create a fine-tuned model.

7. The method as claimed in claim 6, wherein the step of generating the self-labeled dataset based on the multiple sets of 3D data and the multiple sets of predicted keypoint coordinates further comprises:
transforming the multiple sets of predicted keypoint coordinates into multiple sets of aligned keypoint coordinates on a unified coordinate system, wherein each set of aligned keypoint coordinates includes the aligned coordinates corresponding to the keypoints;
calculating a set of representative keypoint coordinates on the unified coordinate system based on the multiple sets of aligned keypoint coordinates, wherein the set of representative keypoint coordinates includes representative coordinates corresponding to the keypoints; and
transforming the set of representative keypoint coordinates into multiple sets of keypoint coordinate labels on camera coordinate systems corresponding to the multiple camera devices;
wherein the set of keypoint coordinate labels corresponding to each camera device, together with the set of 3D data obtained from that camera device, forms a set of self-labeled data in the self-labeled dataset.

8. The method as claimed in claim 7, wherein the step of calculating the set of representative keypoint coordinates on the unified coordinate system based on the multiple sets of aligned keypoint coordinates further comprises:
excluding an outlier from the aligned coordinates corresponding to each keypoint, and calculating the representative coordinate corresponding to the keypoint based on the remaining aligned coordinates.

9. The method as claimed in claim 6, wherein the step of obtaining the multiple sets of 3D data associated with the 3D entity from multiple camera devices further comprises:
converting raw images or depth maps, obtained by the camera devices capturing the 3D entity, into 3D point clouds, and using the 3D point clouds as the multiple sets of 3D data.

10. The method as claimed in claim 6, wherein the pre-trained model and the fine-tuned model are implemented based on a 3D convolutional neural network.
